(19) United States
(12) Patent Application Publication
(10) Pub. No.: US 2009/0198782 A1
(43) Pub. Date: Aug. 6, 2009

(54) APPARATUS, SYSTEM, AND METHOD FOR RETRIEVING EMAIL ATTACHMENTS

(76) Inventors: Shannon Hsinhen Chang, Vail, AZ (US); Khanh Vi Ngo, Tucson, AZ (US)

Correspondence Address: Kunzler & McKenzie, 8 EAST BROADWAY, SUITE 600, SALT LAKE CITY, UT, 84111, US

(21) Appl. No.: 12/025,680

(22) Filed: Feb. 4, 2008

(51) Int. Cl. G06F 15/16

(52) U.S. Cl. 709/206

(57) ABSTRACT

An apparatus, system, and method are disclosed for retrieving email attachments. An email module receives an attachment selection from an attachment interface appended to an attachmentless email. The attachmentless email comprises a body of an original email. The original email comprises an attached file. A target communication module communicates an attachment request from a target email server to a source email server. A source communication module communicates the original email from the source email server to the target email server. A replacement module replaces the attachmentless email with the original email on the target email server so that only the original email is accessible.

### BACKGROUND OF THE INVENTION

1. Field of the Invention

This invention relates to email attachments and more particularly relates to retrieving email attachments.

2. Description of the Related Art

Email users are receiving increasing numbers of email messages. In addition to emails related directly to a user, the user is also copied on many messages. Many email users regularly receive hundreds and even thousands of emails daily.

Many emails include attached files. These attached files swell the data storage requirements for storing emails on servers. In addition, much Internet traffic is devoted to transmitting attached files.

Unfortunately, many of the attached files transmitted over the Internet and stored on servers is either unwanted, or not used by the recipient. As a result, significant computing and communication resources are devoted to unwanted attached files.

### SUMMARY OF THE INVENTION

From the foregoing discussion, there is a need for an apparatus, system, and method that retrieves email attachments. Beneficially, such an apparatus, system, and method would retrieve email attachments and help receivers to identify email attachments of interest.

The present invention has been developed in response to the present state of the art, and in particular, in response to the problems and needs in the art that have not yet been fully solved by currently available methods for storing and retrieving email attachments. Accordingly, the present invention has been developed to provide an apparatus, system, and method for storing and retrieving email attachments that overcome many or all of the above-discussed shortcomings in the art.

The apparatus to retrieve email attachments is provided with a plurality of modules configured to functionally execute the steps of receiving an attachment selection, performing an attachment lookup, communicating an original email, and replacing an attachmentless email. These modules in the described embodiments include an email module, a target communication module, a source communication module, and a replacement module.

The email module receives an attachment selection from an attachment interface appended to an attachmentless email sent to an attachmentless courtesy copy user. The attachmentless email comprises the entire body of the original email plus some additional text to perform the original email request with attachment. The original email comprises an attached file. The attachmentless email and the original email are linked with unique attachment tags. The attachment tags are created for the attachmentless email and the original email.

The target communication module performs an attachment lookup for the attachment tag original email. The source communication module communicates the original email from the source email server to the target email server. The replacement module replaces the attachmentless email with the original email on the target email server so that only the original email is accessible.

A system of the present invention is also presented to retrieve email attachments. In particular, the system, in one embodiment, includes a source email server, a target email server, and an email module.

The source email server comprises a generation module and a source communication module. The generation module creates an attachmentless email from the body of an original email and an attachment interface. The original email comprises an attached file. The attachmentless email and the original email are linked with unique attachment tags. The attachment tags are created for the attachmentless email and the original email. The source communication module communicates the attachmentless email to an address listed in the attachmentless courtesy copy field.

The target email server receives the attachmentless email sent to an attachmentless courtesy copy user. The email module presents the attachmentless email to a user and receives an attachment selection from the attachment interface. The target email server further comprises a target communication module. The target communication module performs an attachment lookup for the attachment tag original email. Additionally, the source communication module further communicates the original email from the source email server to the target email server.

The target email server further comprises a replacement module. The replacement module replaces the attachmentless email with the original email on the target email server so that only the original email is accessible. The email module presents the attachmentless email to a user.

A method of the present invention is also presented for retrieving email attachments. The method in the disclosed embodiments substantially includes the steps to carry out the functions presented above with respect to the operation of the described apparatus and system. In one embodiment, the method includes receiving an attachment, performing an attachment lookup, communicating an original email, and replacing an attachmentless email. The method also may include creating the attachmentless email, communicating the attachmentless email, and storing the attachmentless email.

An email module receives an attachment selection from an attachment interface appended to an attachmentless email sent to an attachmentless courtesy copy user. The attachmentless email comprises a body of an original email. The original email comprises an attached file. The attachmentless email and the original email are linked with unique attachment tags. The attachment tags are created for the attachmentless email and the original email.

A target communication module performs an attachment lookup for the attachment tag original email. A source communication module communicates the original email from the source email server to the target email server. A replacement module replaces the attachmentless email with the original email on the target email server so that only the original email is accessible.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention provides an apparatus, a system, and a method for retrieving email attachments. Beneficially, such an apparatus, a system, and a method would automatically create attachmentless emails and may allow a user to selectively receive the attachments. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an email system in accordance with the present invention;

FIG. 2 is a drawing illustrating one embodiment of an original email with an attachment of the present invention;

FIG. 3 is a drawing illustrating one embodiment of a received original email with the attachment of the present invention;

FIG. 4 is a schematic block diagram illustrating one embodiment of an attachmentless email of the present invention;

FIG. 5 is a schematic block diagram illustrating one embodiment of an attachment retrieval apparatus of the present invention; and

FIG. 6 is a schematic flow chart diagram illustrating one embodiment of an attachment retrieval method of the present invention.

### DETAILED DESCRIPTION OF THE INVENTION

Many of the functional units described in this specification have been labeled as modules, in order to more particularly emphasize their implementation independence. Modules may include hardware circuits such as one or more processors with memory, Very Large Scale Integration (VLSI) circuits, gate arrays, programmable logic, and/or discrete components. The hardware circuits may perform hardwired logic functions, execute computer readable programs stored on tangible storage devices, and/or execute programmed functions. The computer readable programs may in combination with a computer system perform the functions of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

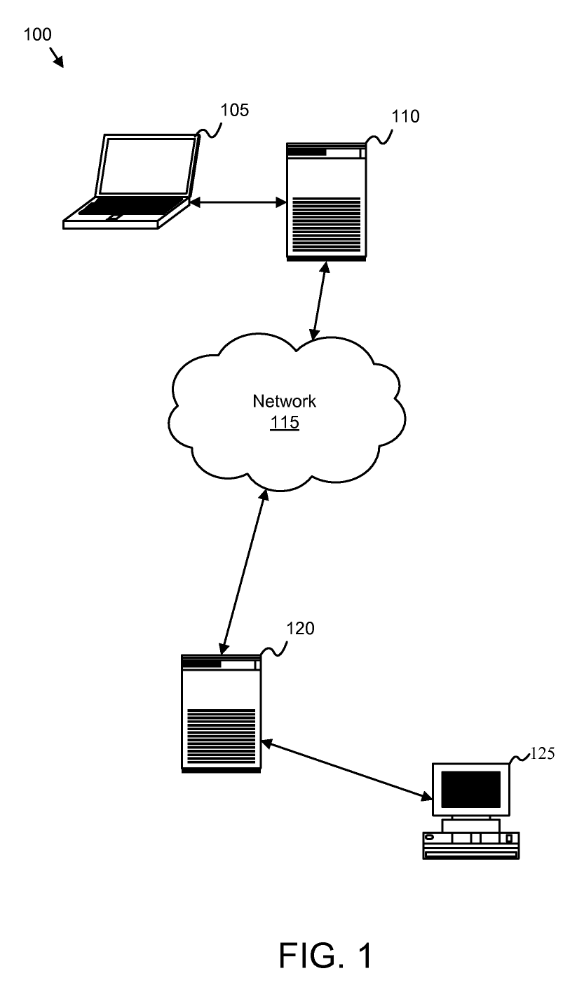

FIG. 1 is a schematic block diagram illustrating one embodiment of an email system 100 in accordance with the present invention. The system 100 includes a network 115, a source email server 110, a target email server 120, a source computer 105, and a target computer 125. Although, for simplicity only one (1) network 115, one (1) source email server 110, one (1) target email server 120, one (1) source computer 105, and one (1) target computer 125 are shown, any number of networks 115, source email servers 110, target email servers 120, source computers 105, and target computers 125 may be used in the system 100.

The source email server 110 and the target email server 120 may be configured as mainframe computers, blade centers comprising multiple blade servers, and the like. Each server 110, 120 may act as the target server 120 and vice-versa. Both the servers 110 and 120 may have their own memory to store the email messages. In a particular example, the source email server 110 and the target email server 120 may be configured as mail servers. The mail servers may use server software such as mail transfer agents (MTAs) selected from Sendmail, Exim, Qmail and Postfix to transfer the email over the network 115.

The network 115 may comprise one or more nodes those may connect the source email server 110 and the target email server 120 for transfer of emails from one user to another. The network 115 may be selected from a local area network (LAN), a wide area network (WAN), an Internet, an Ethernet network, a token ring network, or the like. The communication over the network 115 may be through cables, wired lines, and the like and/or wireless.

The source computer 105 and the target computer 125 may be selected from a desktop, a laptop, a mobile phone, a palmtop, or the like. The source computer 105 and the target computer 125 may include a processor, memory, a monitor, a keyboard, a mouse, and the like.

In an embodiment, a user sending an original email and another user receiving the email may be referred as a sender and a recipient respectively. The sender may compose the email using an email program such as MICROSOFT® OUTLOOK®, YAHOO® MAIL, MSN® HOTMAIL®, and the like on the source computer 105 for a plurality of recipients. The plurality of recipients may receive and read the email on their respective target computers 105 using the email program.

The source computer 105 may communicate with the source email server 110 to transfer the composed email from the source computer 105 to the source email server 110. Further, the source email server 110 may find the target email server 120 and may deliver the email to the target email server 120. There may be a plurality of target email servers 120 receiving the email from the source email server 110. The target email server 120 may store the received email until the recipient retrieves the email. When the recipient retrieves the email, the target email server 120 may communicate with the target computer 125 to transfer the email onto the target computer 125.

During composing and transferring the email, a plurality of headers may be added. Each selected header may be configured as a header field. In an embodiment, the plurality of headers are selected from a To: a Courtesy Copy (CC:), Attachmentless Courtesy Copy (ACC:), a Blind Courtesy Copy (BCC:), a From:, and the like. Each selected header may be transmitted as a single line of text during the email transfer. Some of the headers, for example, the TO: header, the From: header, and the like may be mandatory. The other headers for example, CC:, ACC:, BCC:, and the like may not be the mandatory.

In an embodiment, the composed email comprises one or more attachments. The one or more attachments attached to the email may be a computer file, for example, a text file, a Portable Document Format (PDF) file, or the like. The attachment may be sent in an unencoded form, or an encoded form by a method selected from a base64, a binhex, a uuencoding, or the like known to those skilled in the art.

All communications between the source email server 110, the target email server 120, the source computer 105, and the target computer 125, and the network 115 may be through cables, optical fibers, and/or wireless connections or the like known to those skilled in the art. In an embodiment, the system 100 provides services for sending, forwarding the emails for the source computer 105 and retrieving or replying to the emails for the target computer 125. In one more embodiment, the email may include a plurality of the header fields, a body field, and an attachment field. The email may be displayed on a monitor of the source computer 105, and/or the target computer 125.

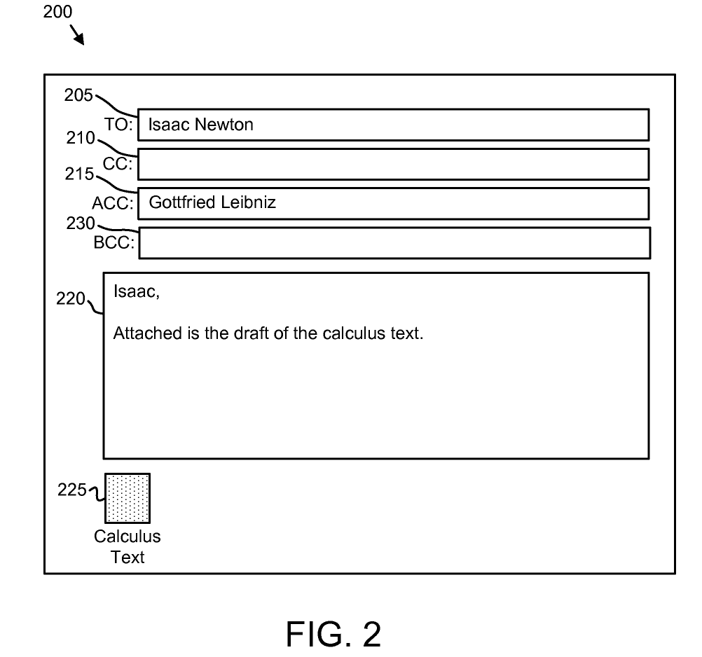

FIG. 2 is a drawing illustrating one embodiment of an original email 200 with an attachment of the present invention. The description of email 200 refers to elements of FIG. 1, like numbers referring to like elements. The email 200 includes a plurality of header fields 205, 210, 215, 230, a body field 220, and an attachment field 225. Although, for simplicity only four (4) header fields 205, 210, 215, and 230, one (1) body field 220, and one (1) attachment field 225 are shown, any number of fields may be used in the email 200.

In the shown embodiment, the header fields 205, 210, 215, and 230 include a TO header field 205, a Courtesy Copy (CC) header field 210, an Attachmentless Courtesy Copy (ACC) header field 215, and a Blind Courtesy Copy (BCC) header field 230 respectively. The TO header field 205 may be a mailing list of a sender. The CC header field 210, the ACC header field 215, and the BCC header field 230 may specify additional recipients.

The sender may send a courtesy copy, an attachmentless copy, and a blind courtesy copy of the original email 200 with or without one or more attachments to the recipients of the CC header field 210, the ACC header field 215, and the BCC header field 230 respectively. A difference between the plurality of header fields 210, 215, and 230 and the header field 205 may be essentially connotative, some mailers may deal with the received email differently in generating replies.

In an embodiment, the CC header field 210, the ACC header field 215, and the BCC header field 230, and the body field 220 provide space for entering one or more email addresses and/or optionally names of recipients and/or an unstructured message respectively. The sender may use a keyboard of the source computer 105 to enter one or more email addresses and/or optionally names and/or the unstructured message respectively.

In the shown embodiment, the TO header field 205 contains the email address or the name of an exemplary recipient ‘Isaac Newton,’ the CC header field 210 is blank, the ACC header field 215 contains the email address or the name of one (1) exemplary recipient ‘Gottfried Leibniz,’ and the BCC header field 230 is blank. Additionally, the email 200 displays the body field 220 containing the exemplary message ‘Isaac, Attached is the draft of the calculus text,’ and the attachment field 225 indicating an exemplary attachment ‘Calculus Text.’

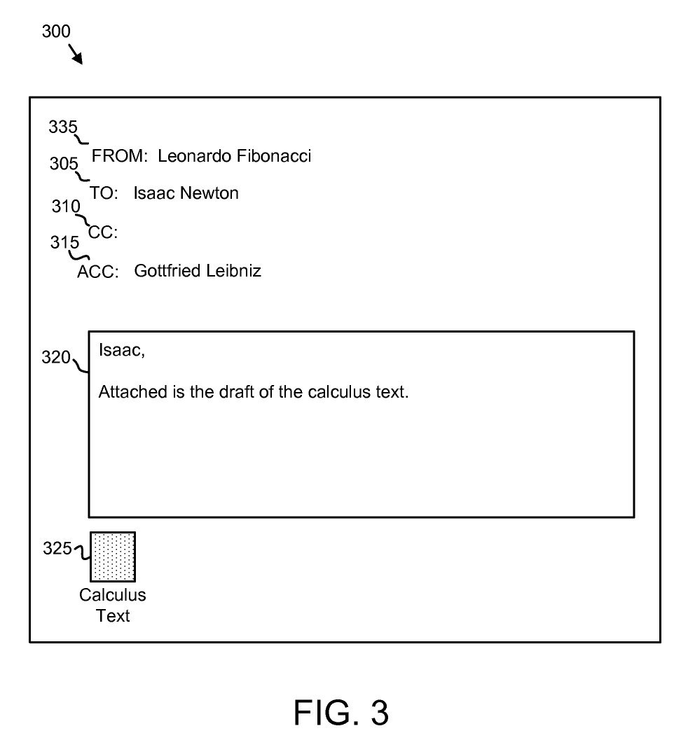

FIG. 3 is a drawing illustrating one embodiment of a received original email 300 with the attachment of the present invention. The description of the received email 300 refers to elements of FIGS. 1 and 2, like numbers referring to like elements. The received email 300 includes a plurality of fields 305, 310, 315, and 335, a body field 320, and an attachment field 325. Although, for simplicity only four (4) fields 305, 310, 315, and 335, one (1) body field 325, and one (1) attachment field 325 are shown, any number of fields may be used in the received email 300.

In an embodiment, the TO field 305 specifies one or more email addresses and/or names of legitimate recipients and the From field 335 specifies an email address and/or name of a sender of the original email with one or more attachments. The CC field 310 and ACC field 315 may specify additional email addresses and/or names of recipients receiving a courtesy copy, an attachmentless copy, and a blind courtesy copy of the original email respectively. The recipients of the TO field 305 and the CC field 310 may receive the original email with one or more attachments. The recipients of the ACC field 330 may receive the attachmentless email.

The body field 320 may display an unstructured message the recipient may view/read. The attachment field 325 may indicate one or more attachments with the original email. In an embodiment, the attachment field 325 is a hypertext linked GUI. The recipient may click the hypertext linked GUI to download one or more attachments with the received email 300.

In the shown embodiment, the From field 335 contains the email address or the name of an exemplary sender ‘Leonardo Fibonacci,’ the TO field 305 contains the email address or the name of an exemplary recipient ‘Isaac Newton,’ the CC field 310 is blank, and the ACC field 315 contains the email address or the name of an exemplary recipient ‘Gottfried Leibniz.’ Additionally, in the shown embodiment, the body field 320 contains an exemplary message ‘Isaac, Attached is the draft of the calculus text’ and the attachment field 325 indicates an exemplary attachment ‘Calculus Text.’

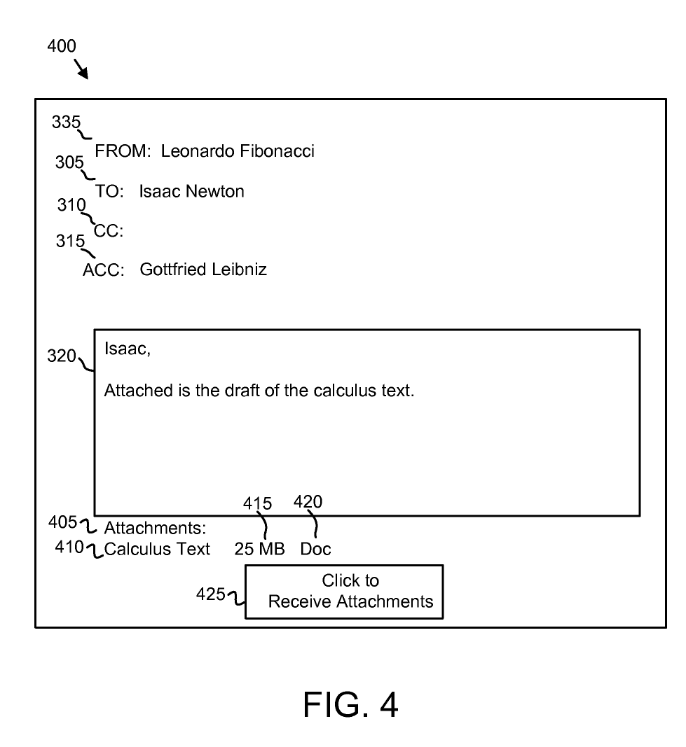

FIG. 4 is a schematic drawing illustrating one embodiment of an attachmentless email 400 of the present invention. The description of attachmentless email 400 refers to elements of FIGS. 1, 2, and 3, like numbers referring to like elements. The attachmentless email 400 includes a plurality of fields 305, 310, 315, and 335, a body field 320, an attachment field 405, an attachment name field 410, an attachment size field 415, an attachment type field 420 and an attachment interface 425. The plurality of fields 305, 310, 315, and 335 and the body field 320 of the attachmentless email 400 may be same as of the received email 300. Although, for simplicity only four (4) header fields 305, 310, 315, and 335, one (1) body field 325, one (1) attachment field 405, one (1) attachment name field 410, one (1) attachment size field 415, one (1) attachment type field 420, and one (1) attachment interface 425, are shown, any number of those may be used in the attachmentless email 400.

In an embodiment, a computer program automatically creates the attachmentless email 400 by removing one or more attachments from the original email 200, but appending to the bottom of the email 400 the attachment interface 420 that instructs the user how to retrieve the attachments if so desired. The attachment interface 420 may be a hypertext link, a graphical user interface (GUI) selection button, a GUI radio button, a GUI pop-up menu, an icon, or the like. The attachmentless email 400 may also include the attachment field 405 that identifies attachment information, the attachment name field 410 that lists a name of each attachment, the attachment size field 415 that lists the file size of each attachment, and the attachment type field 420 that lists the file type of the attachment.

The target email server 120 receives the attachmentless email 400. One or more recipients specified by the ACC field 315 may receive the attachmentless email 400 from the target email server 120. The attachment field 405 of the attachmentless email 400 may indicate one or more removed attachments from the original email 200. The attachment interface 425 may be configured as a hypertext linked GUI. When the recipient hovers a cursor on the attachment interface 425 configured as a hypertext linked GUI a list containing names of one or more attachments may appear. The recipient may click the particular attachment to download the indicated one or more removed attachments.

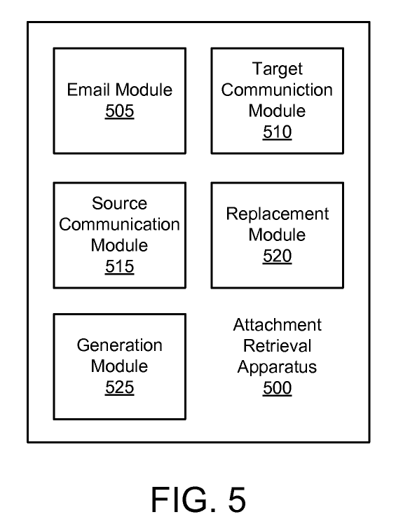

FIG. 5 is a schematic block diagram illustrating one embodiment of an attachment retrieval apparatus 500 of the present invention. The system 100 of FIG. 1 may embody the apparatus 500. The description of apparatus 500 refers to elements of FIGS. 1-4, like numbers referring to like elements. The apparatus 500 includes an email module 505, a target communication module 510, a source communication module 515, and a replacement module 520. The apparatus 500 may further include a generation module 525.

The email module 505 receives an email attachment selection from an attachment interface 425 appended to an attachmentless email 400 that is sent to an ACC user. The attachmentless email 400 comprises a body 320 of an original email 400. The original email 200 comprises an attached file. The attachmentless email 400 may comprise the body 320 and the attachment interface 425. The email selection may request receiving the original email 200 with one or more attachments. The email module 505 may be a computer readable program.

In an embodiment, the email module 505 renders the attachment interface 425 as a GUI control. The attachment interface 425 may be configured as a GUI selected from a hypertext link, a selection button, a radio button, a pop-up menu, an icon, or the like. The attachment interface 425 may be configured as a hypertext link. The hypertext link may be through a uniform resource locator (URL) with the target email server 120. For example, the attachment interface 425 may be in the form of the text box ‘Receive Attachments.’Further, continuing with the example above, the email module 505 may automatically render the attachment interface 425 as the GUI control.

The email module 505 may create unique attachment tags for the email 200 and attachmentless email 400. The generation module 525 may create the attachmentless email 400 from the body 320 of the original email 200 and the attachment interface 425. The attachmentless email 400 and the original email 200 are linked with the unique attachment tags. The attachment tags may comprise a string of alphanumeric characters that identify the attachmentless email 400/original email 200 pair. In addition, the attachment tags may identify the source email server 120. The source email server 120 comprises the generation module 525. The generation module 525 may be a computer readable program.

In an embodiment, the source communication module 515 may communicate the attachmentless email 400 to an address listed in an attachmentless copy field. For example, the source communication module 515 may select one or more addresses from the list of the recipients listed in the ACC field 315. The source communication module 515 may further communicate the attachmentless email 400 in an operation selected from sending, forwarding, replying, and replying to all. The operations of sending, forwarding, replying, and replying to all are well known to those skilled in the art. For example, the source communication module 515 may communicate the attachmentless email 400 to one or more addresses listed in the ACC field 315 of attachmentless email 400. The source email server 120 comprises the source communication module 515. The source communication 515 may be a computer readable program.

The target communication module 510 may store the attachmentless email 400 on the target email server 120. In an embodiment, the target email server 120 comprises the target communication module 510. The target communication module 510 may be computer readable program.

The target communication module 510 performs an attachment lookup for the original email linked to the attachment tag of the attachmentless email 400. For example, the target communication module 510 may search the target email server 120 and the source email server 110 for the original email 200 with an attachment tag corresponding to the attachment tag of the attachmentless email 400.

In one embodiment, the source communication module 515 communicates the original email 200 from the source email server 110 to the target email server 120. For example, if the attachment tag matches an attachment tag of the original email 200 stored on the source server 110, the source communication module 515 may communicate the original email 200 from the source email server 110 to the target email server 120.

The replacement module 520 replaces the attachmentless email 400 with the received original email 300 on the target email server 120 so that only the received original email 300 is accessible. For example, when the source communication module 515 communicates the original email 200 from the source email server 110 to the target email server 120, the replacement module 520 may replace the attachmentless email 400 with the original email 200 on the target email server 120 so that only the original email 200 is accessible. In an embodiment, the target email server 120 comprises the replacement module 520. The target replacement module 530 may be computer readable program.

In an embodiment, the email module 505 further presents the received original email 300 to a user. For example, when the replacement module 520 replaces the attachmentless email 400 with the received original email 300 on the target email server 120, the email module 505 may present the received original email 300 to the user ‘Gottfried Leibniz.’

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

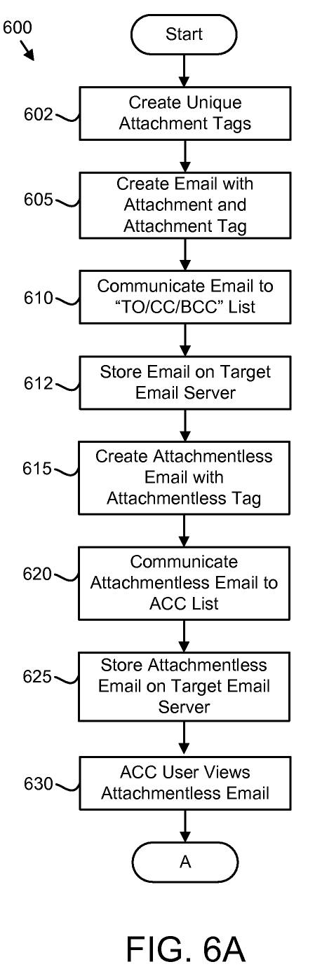

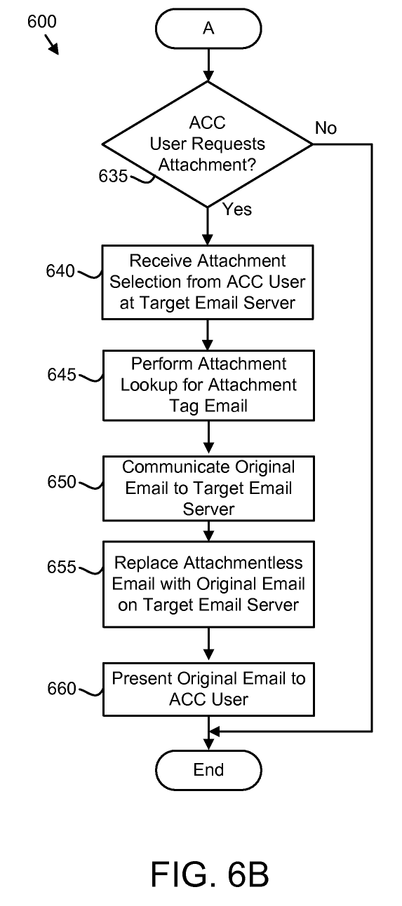

FIG. 6 is a schematic flow chart illustrating one embodiment of a method 600 for retrieving email attachments. The method 600 substantially includes the steps to carry out the functions presented above with respect to the operation of described system 100 and apparatus 500 of FIGS. 1 and 5. The description of method 600 refers to elements of FIGS. 1-5, like numbers referring to the like elements.

In one embodiment, the method 600 is implemented with a computer program product comprising a computer readable medium having a computer readable program. The computer program product in combination with the computing system may be capable of performing the method 600. The computer program readable medium may be executed by the source computer 105, source email server 110, the target email server 120, and the target computer 125.

The method 600 starts and in an embodiment, the email module 505 creates 602 unique attachment tags to identify the original email 200 and the attachmentless email 400 so that the original email 200 and the attachmentless email 400 are linked together as a pair. In one embodiment, the attachment tag identifies the originator and includes a time stamp. In a certain embodiment, the attachment tag includes a pseudo random number.

The email module 505 further creates 605 the original email 200 with the attachment and the attachment tag. For example, the email module 505 may automatically create 605 the TO header field 205, the CC header field 210, the ACC header field 215, the BCC header field 230, the body filed 220, and the attachment field 225, receive necessary data from the sender, and fill the received data in the corresponding fields to create the original email 200. The email module 505 may further append the attachment tag to the original email 200.

The source communication module 515 may communicate 610 the original email 200 with the attachment to the list of the recipients of the TO header field 205, the CC header field 210, and the BCC header field 230. For example, the source communication module 515 may automatically communicate send 610 the original email 200 with the attachment to the exemplary recipient ‘Isaac Newton’ listed in the TO header field 205. In one embodiment, the target communication module 510 stores 612 the original email 200 on the target email server 120.

In an embodiment, the generation module 525 creates 615 the attachmentless email 400 with the attachment tag from the body 320 of the original email 200 and the attachment interface 425. For example, the generation module 525 may remove the exemplary attachment ‘Calculus Text’ form the original email 200 and further may create and append a header configured as the attachment interface 425 to create 615 the attachmentless email 400. The generation module 525 may modify the attachment tag of the original email 200 to differentiate the attachmentless email 400 from the original email 200. Alternatively, the attachment tag of the original email 200 is incorporated unchanged in the attachmentless email 400.

The source communication module 515 may communicate 620 the attachmentless email 400 to the address listed in the attachmentless copy field. The attachmentless copy field may be the ACC field 215 of the original email 200. The source communication module 515 may further communicate 620 the attachmentless email 400 in an operation selected from sending, forwarding, replying, and replying to all. For example, the source communication module 515 may communicate 620 the attachmentless email 400 to the address ‘Gottfried Leibniz’ listed in the ACC field 215. Alternatively, the user may reply to a sender and/or the sender and all recipients of an email 200 with the attachmentless email 400 so that the sender and/or other recipients do not have duplicate copies of attachments. In a certain embodiment, the user forwards an email 200 as an attachmentless email 400 to a new recipient.

The target communication module 510 may store 625 the attachmentless email 400 on the target email server 120. For example, the target communication module 510 may automatically store 625 the attachmentless email 400 on the target email server 120.

An ACC user may view 630 the attachmentless email 400. The ACC user may be the recipient listed in the ACC field 315 of the original email 200. For example, the recipient ‘Gottfried Leibniz’ may view 630 the attachmentless email 400.

The ACC user may request 635 the attachment. For example, the recipient ‘Gottfried Leibniz’ may request 635 for the attachment ‘Calculus Text’ by an attachment selection. The ACC user selects the attachment interface 425 to make the attachment selection.

If the user does not request 635 for the attachment, the method 600 ends. If the user requests 635 the attachment, the target email server 120 receives the email attachment selection from the attachment interface 425 appended to the attachmentless email 400. In an embodiment, the email module 505 renders the attachment interface 425 as the graphical user interface control. The attachment interface 425 may be configured as the hypertext link. For example, the recipient ‘Gottfried Leibniz’ may hover a cursor on the attachment interface 425 to display a list containing the name of the exemplary attachment ‘Calculus Text.’ The ACC user may request 635 for the attachment by clicking on the attachment interface 425 and the target email server 120 may receive 640 the email attachment selection.

The target communication module 510 performs 645 an attachment lookup for the attachment tag original email 200. For example, the target communication module 510 may search original emails 200 stored on the target email server 120 for an attachment tag corresponding to the attachment tag of the attachmentless email 400.

If the target communication module 510 does not find the original email 200 with the attachment tag on the target email server 120, the target communication module 510 may request the original email 200 from the source email server 110. The source communication module 515 communicates 650 the original email 200 from the source email server 110 to the target email server 120.

When the target communications module 510 finds the original email 200, the replacement module 520 replaces 655 the attachmentless email 400 with the original email 200 on the target email server 120 so that only the original email 200 is accessible by the ACC user. In one embodiment, the replacement module 520 overwrites the attachmentless email 400 with the original email 200.

The email module 505 may present 660 the received original email 300 to the ACC user. The email module 505 may present 660 the original email 200 during a refresh operation of an email client that embodies the email module 505.

The present invention provides an apparatus, a system, and a method for retrieving email attachments. Beneficially, such an apparatus, a system, and a method would automatically create attachmentless emails and may allow a user to selectively receive the attachments. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having a:
computer readable program, wherein the computer readable program when executed on a computer causes the computer to:
receive an attachment selection from an attachment interface appended to an attachmentless email sent to an attachmentless courtesy copy user, wherein the attachmentless email comprises a body of an original email, the original email comprising an attached file, and the attachmentless email and original email are linked with unique attachment tags created for the attachmentless email and the original email;
perform an attachment lookup for the attachment tag original email;
communicate the original email from the source email server to the target email server in response to the attachment request; and
replace the attachmentless email with the original email on the target email server so that only the original email is accessible.

2. The computer program product of claim 1, wherein the computer readable program is further configured to cause the computer to create the attachmentless email from the body of the original email and the attachment interface.

3. The computer program product of claim 1, wherein the computer readable program is further configured to cause the computer to communicate the attachmentless email to an address listed in an attachmentless courtesy copy field.

4. The computer program product of claim 3, wherein the computer readable program is further configured to cause the computer to communicate the attachmentless email in an operation selected from sending, forwarding, replying, and replying to all.

5. The computer program product of claim 1, wherein the computer readable program is further configured to cause the computer to store the attachmentless email on the target email server.

6. The computer program product of claim 1, wherein the computer readable program is further configured to cause the computer to present the original email to a user.

7. The computer program product of claim 1, wherein the attachment selection is selected from a hypertext link, a graphical user interface selection button, a graphical user interface radio button, a graphical user interface pop-up menu, and an icon.

8. The computer program product of claim 1, wherein the computer readable program is further configured to cause the computer to render the attachment interface as a graphical user interface control.

9. An apparatus to retrieve attachments, the apparatus comprising:
an email module configured to receive an attachment selection from an attachment interface appended to an attachmentless email sent to an attachmentless courtesy copy user, wherein the attachmentless email comprises a body of an original email, the original email comprising an attached file, and the attachmentless email and original email are linked with unique attachment tags created for the attachmentless email and the original email;
a target communication module configured to perform an attachment lookup for the attachment tag original email;
a source communication module configured to communicate the original email from the source email server to the target email server; and
a replacement module configured to replace the attachmentless email with the original email on the target email server so that only the original email is accessible.

10. The apparatus of claim 9, further comprising a generation module configured to create the attachmentless email from the body of the original email and the attachment interface.

11. The apparatus of claim 9, the email module further configured to present the original email to a user.

12. The apparatus of claim 9, wherein the email module is further configured to render the attachment interface as a graphical user interface control.

13. The apparatus of claim 9, wherein the source communication module is further configured to communicate the attachmentless email to an address listed in an attachmentless courtesy copy field.

14. The apparatus of claim 9, wherein the source communication module is further configured to communicate the attachmentless email in an operation selected from sending, forwarding, replying, and replying to all.

15. The apparatus of claim 9, wherein the target communication module is further configured to store the attachmentless email on the target email server.

16. The apparatus of claim 9, wherein the attachment selection is selected from a hypertext link, a graphical user interface selection button, a graphical user interface radio button, a graphical user interface pop-up menu, and an icon.

17. A system to retrieve attachments, the system comprising:
a source email server comprising
a generation module configured to create an attachmentless email from the body of an original email and an attachment interface, the original email comprising an attached file, and the attachmentless email and original email are linked with unique attachment tags created for the attachmentless email and the original email;
a source communication module configured to communicate the attachmentless email to an address listed in an attachmentless courtesy copy field;
a target email server configured to receive the attachmentless email;
an email module configured to present the attachmentless email to a user and receive an attachment selection from the attachment interface;
the target email server further comprising a target communication module configured to perform an attachment lookup for the attachment tag original email;
the source communication module further configured to communicate the original email from the source email server to the target email server;
the target email server further comprising a replacement module configured to replace the attachmentless email with the original email on the target email server so that only the original email is accessible.

18. The system of claim 17, wherein the source communication module is further configured to communicate the attachmentless email in an operation selected from sending, forwarding, replying, and replying to all.

19. The system of claim 17, the email module further configured to present the original email to a user.

20. The system of claim 17, wherein the attachment selection is selected from a hypertext link, a graphical user interface selection button, a graphical user interface radio button, a graphical user interface pop-up menu, and an icon.
